(19) United States
(12) Patent Application Publication
(10) Pub. No.: US 2024/0161637 A1
(43) Pub. Date: May 16, 2024

(54) DYNAMIC CONTEXT-BASED UNMANNED AERIAL VEHICLE AUDIO GENERATION ADJUSTMENT

(71) Applicant: INTERNATIONAL BUSINESS MACHINES CORPORATION, ARMONK, NY (US)

(72) Inventors: Martin G. Keen, Cary, NC (US); Jana H. Jenkins, Raleigh, NC (US); XIN WANG, Chappaqua, NY (US); Jennifer A. Mallette, Vienna, VA (US)

(21) Appl. No.: 18/055,429

(22) Filed: Nov. 15, 2022

(51) Int. Cl. G08G 5/00; B64C 39/02

(52) U.S. Cl. CPC G08G 5/0073; B64C 39/024; B64C 2201/141

(57) ABSTRACT

According to one embodiment, a method, computer system, and computer program product for dynamic acoustics adjustment is provided. The embodiment may include capturing contextual information of an environment surrounding an unmanned aerial vehicle (UAV). The embodiment may also include generating an environmental model using a cluster of machine learning techniques based on the captured contextual information. The embodiment may further include identifying one or more dominant sounds within a soundscape of the captured contextual information. The embodiment may also include calculating an impact of an operation of the UAV on one or more activities within the environment based on the generated environmental model and the one or more identified dominant sounds. The embodiment may further include, in response to determining the calculated impact affects an activity within the one or more activities, modifying the operation to minimize the impact on the soundscape.

### BACKGROUND

The present invention relates generally to the field of computing, and more particularly to unmanned aerial vehicles.

Unmanned aerial vehicles (UAVs) may relate to any vehicle capable of flight without any human occupants (e.g., pilot, crew, or passengers). UAVs may exhibit varying degrees of autonomy, such as semi-autonomous (e.g., autopilot assistance) or fully autonomous. Furthermore, UAVs may have any number of equipped sensors capable of capturing information in the environment surrounding the UAV and transferring the captured information to either an onboard processing unit or to a cloud processing unit through a network. UAVs may utilize one or more propulsion mechanisms, such as, but not limited to, spinning rotors or turbines, jet engines, and flapping-wing propulsion (e.g., ornithopters). Additionally, UAVs may be powered by one or more various types of energy sources including, but not limited to, internal combustion engines, solar-power, or battery power.

### SUMMARY

According to one embodiment, a method, computer system, and computer program product for dynamic acoustics adjustment is provided. The embodiment may include capturing contextual information of an environment surrounding an unmanned aerial vehicle (UAV). The embodiment may also include generating an environmental model using a cluster of machine learning techniques based on the captured contextual information. The embodiment may further include identifying one or more dominant sounds within a soundscape of the captured contextual information. The embodiment may also include calculating an impact of an operation of the UAV on one or more activities within the environment based on the generated environmental model and the one or more identified dominant sounds. The embodiment may further include, in response to determining the calculated impact affects an activity within the one or more activities, modifying the operation to minimize the impact on the soundscape.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a dynamic acoustics adjustment process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to unmanned aerial vehicles (UAVs). The following described exemplary embodiments provide a system, method, and program product to, among other things, analyze the environment in which a UAV, or a UAV swarm, is operating and dynamically adjust behaviors to minimize any disruption to the environmental soundscape. Therefore, the present embodiment has the capacity to improve the technical field of UAVs by minimizing any effect presented to an environmental soundscape by the presence and operation of a UAV. Additionally, although previously described as applicable to the field of UAVs, the present invention may also be applicable to the field of automatic noise control due to dynamic modifications to UAV operation that result in the impact reduction on an environmental soundscape and contextual setting and the lessening of noise pollution.

As previously described, UAVs may relate to any vehicle capable of flight without any human occupants (e.g., pilot, crew, or passengers). UAVs may exhibit varying degrees of autonomy, such as semi-autonomous (e.g., autopilot assistance) or fully autonomous. Furthermore, UAVs may have any number of equipped sensors capable of capturing information in the environment surrounding the UAV and transferring the captured information to either an onboard processing unit or to a cloud processing unit through a network. UAVs may utilize one or more propulsion mechanisms, such as, but not limited to, spinning rotors or turbines, jet engines, and flapping-wing propulsion (e.g., ornithopters). Additionally, UAVs may be powered by one or more various types of energy sources including, but not limited to, internal combustion engines, solar-power, or battery power.

UAVs are becoming increasingly population for various activities from photography to agriculture to disaster relief. The versatility and low cost of UAV systems has led to a growing market, but drawback still exist in their usage. One such drawback is the pitch and tone generated by UAVs, specifically rotor-powered UAVs, which can be jarring, unpleasant, and disruptive.

Many UAVs that utilize rotors for flight are deployed with four or more rotors, which each generate a pitch and harmonic. These generated pitches and harmonics create an unpleasant and discordant soundscape, particularly when the UAV is flying close to individuals or in an environment with other noise sources. Pitch from UAV rotors may create a high pitch noise similar to a swarm of insects. Various UAVs generate rotor noise at various frequencies based on factors such as the rotor shape. At times, the generated noise maybe of little consequence due to lack of people to be affected or competing noise within the soundscape (e.g., stock car racing). However, in other situations, particularly in UAV swarms where sounds can be amplified, the generated noise can be highly disruptive and unwanted, such as in a wedding ceremony or prior to a golfer performing a tee shot. As such, it may be advantageous to, among other things, establish an effective mitigation solution that adjusts the pitch of UAV audio in response to the environmental and contextual setting around a UAV in operation.

According to one embodiment, a dynamic acoustics adjustment program may utilize machine learning algorithms to detect the environment or contextual setting of an area intersecting with the expected flight path of a UAV. The dynamic acoustics adjustment program may also derive an optimal pitch and tone for rotor-produced audio based on the detected environment or contextual setting. Furthermore, the dynamic acoustics adjustment program may dynamically modify the shape, angle, and/or rotation speed of a UAV rotor blade to generate the desired pitch and tone in real-time to match the optimal pitch for the current environment and contextual setting thereby reducing or eliminating any disruption or unpleasantness to the soundscape produced by the UAV's operation.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

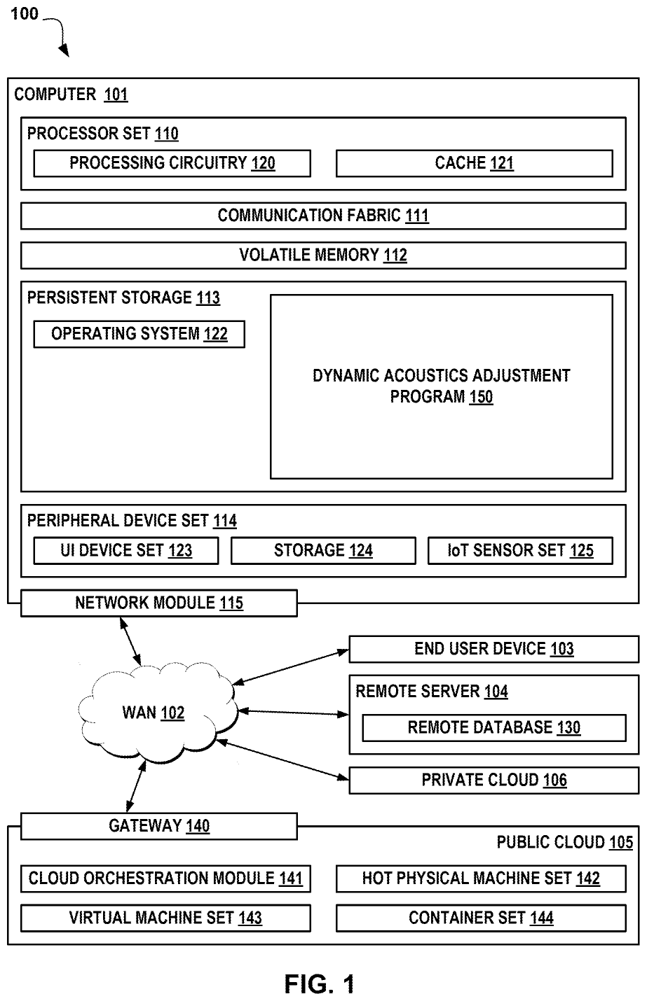

Referring now to FIG. 1, computing environment 100 contains an example of an environment for the execution of at least some of the computer code involved in performing the inventive methods, such as dynamic acoustics adjustment program 150. In addition to dynamic acoustics adjustment program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and dynamic acoustics adjustment program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in dynamic acoustics adjustment program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in dynamic acoustics adjustment program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

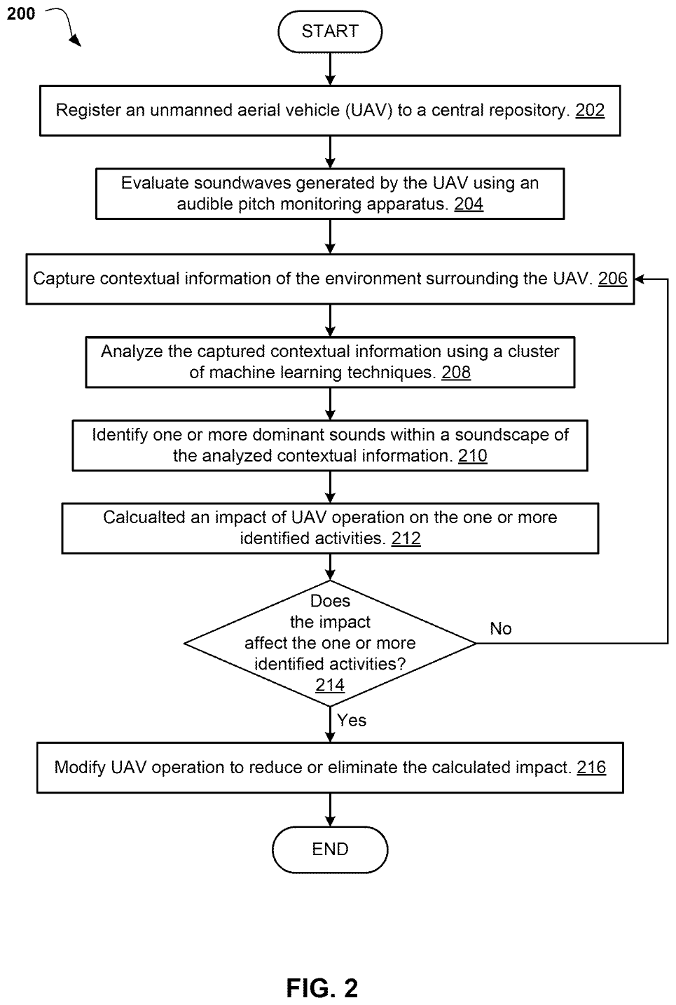

According to at least one embodiment, the dynamic acoustics adjustment program 150 may capture information related to environmental and contextual settings through a series of sensors, such as IoT sensor set 125. The dynamic acoustics adjustment program 150 may then derive an acoustic impact on the environment and contextual setting of a UAV during operation along a flight path. If the dynamic acoustics adjustment program 150 determines the UAV operation is disruptive or impactful on the environment and contextual setting, the dynamic acoustics adjustment program 150 may perform a mitigation modification to the operational components of the UAV (e.g., rotor speed, rotor pitch, rotor angle, and rotor shape) to reduce or eliminate any impact to the environment and/or contextual setting. Furthermore, notwithstanding depiction in computer 101, the dynamic acoustics adjustment program 150 may be stored in and/or executed by, individually or in any combination, end user device 103, remote server 104, public cloud 105, and private cloud 106. It may be appreciated that the examples described below are not intended to be limiting, and that in embodiments of the present invention the parameters used in the examples may be different. The dynamic acoustics adjustment method is explained in more detail below with respect to FIG. 2.

Referring now to FIG. 2, an operational flowchart for a dynamic acoustics adjustment process 200 is depicted according to at least one embodiment. At 202, the dynamic acoustics adjustment program 150 registers a UAV to a central repository. The dynamic acoustics adjustment program 150 may require a user to opt-in to using the dynamic acoustics adjustment program 150 through a registration process. The registration process may include a full list of specifications of the UAV, such as, but not limited to, speed, weight, onboard sensor capacity, and rotor specifications and dimensions. In at least one embodiment, the UAV may be a further form of computer 101 in addition to the forms previously described. Therefore, the registration process performed by the dynamic acoustics adjustment program 150 may transmit the full list of specifications for the UAV to the central repository, such as remote database 130 on remote server 104 or on a storage module associated with EUD 103 or private cloud 106, through WAN 102.

Then, at 204, the dynamic acoustics adjustment program 150 evaluates soundwaves generated by the UAV using an audible pitch monitoring apparatus. The dynamic acoustics adjustment program 150 may evaluate the UAV through an audible pitch monitoring apparatus to derive soundwave information generated by operation of the rotors and general operation. The audible pitch monitoring apparatus may be a sensor within IoT sensor set 125 capable of capturing various sound metrics including, but not limited to, sound frequency, decibel level, and overall tone. The dynamic acoustics adjustment program 150 may capture the soundwave information at various modes of UAV operation including, but not limited to, different rotor speeds and various rotary movements. Furthermore, if a UAV offers adjustable rotor blade capabilities, the dynamic acoustics adjustment program 150 may provide analysis of each of the various adjustable rotor blade capabilities.

Once evaluation is complete, the dynamic acoustics adjustment program 150 may create an acoustics model for the UAV that includes the various sound metrics. Additionally, the dynamic acoustics adjustment program 150 may create a unique audible profile, in the central repository, for each UAV registered to the central repository that includes the created acoustics model.

Next, at 206, the dynamic acoustics adjustment program 150 captures contextual information of the environment surrounding the UAV. As the UAV is operated, the dynamic acoustics adjustment program 150 utilizes onboard sensors, such as IoT sensor set 125, to capture contextual information relevant to the environmental surroundings of the UAV. In addition to the forms described in FIG. 1, IoT sensor set 125 may further include, but is not limited to, proximity sensors, accelerometers, infrared sensors, pressure sensors, light sensors, ultrasonic sensors, touch sensors, color sensors, humidity sensors, position sensors, magnetic sensors (e.g., Hall effect sensor), sound sensors (e.g., microphones), tilt sensors (e.g., gyroscopes), flow sensors, level sensors, strain sensors, and weight sensors.

In at least one embodiment, the dynamic acoustics adjustment program 150 may utilize visual sensors, audio sensors, location sensors, and motion sensors to capture various forms of relevant environmental information. Visual sensors may include onboard photographic capture devices, infrared cameras, and other visual mapping tools capable of capturing the environment within which the UAV is operating. The data captured through visual sensors may be used to identify objects, landmarks, living organisms, and other features within the environment.

The audio sensors, such as microphones, may capture audio information about the surrounding environment. The dynamic acoustics adjustment program 150 may utilize the captured audio information to identify various sounds emanating from the surrounding environment. Furthermore, the dynamic acoustics adjustment program 150 may utilize two or more audio sensors, either affixed to the same UAV or two or more UAVs, to identify the source of the various sounds through various techniques, such as triangulation. Furthermore, the dynamic acoustics adjustment program 150 may utilize ultrasound sensors to identify objects and obstructions within the environment.

The location sensors, such as a global positioning system or a cellular triangulation system, may identify a UAV positional location through geographic coordination. Through the geographic information captured by location sensors, the dynamic acoustics adjustment program 150 may determine the type of environment in which the UAV is currently operating or over which the UAV will travel according to a predicted flight path. For example, by inputting the geographic coordinates captured from the location sensors into a remote database mapping system, the dynamic acoustics adjustment program 150 may identify the UAV is traveling over a forest.

The motion sensors, such as accelerometers and gyroscopes, may be used to detect the movement of the UAV. The dynamic acoustics adjustment program 150 may utilize the motion information captured by the motion sensors to identify when the UAV is moving and the velocity and acceleration with which it is moving.

Next, at 208, the dynamic acoustics adjustment program 150 generates a model of the environment from the captured contextual information using a cluster of machine learning techniques. The dynamic acoustics adjustment program 150 may generate a model of the environment surrounding the UAV based on the contextual information The dynamic acoustics adjustment program 150 may utilize the model to further determine the impact of the UAV's operation within the environment and the activities associated with the one or more dominant sounds as described in step 210. The environmental model may be a representation (e.g., a visual representation or a mathematical representation) of the elements within the contextual information as captured by onboard UAV sensors and the soundwaves emitted by the one or more activities

In at least one embodiment, the dynamic acoustics adjustment program 150 may utilize one or more machine learning techniques, such as, but not limited to, convolutional neural networks (CNNs), recurrent neural networks (RNNs), and support vector machines (SVMs), to generate the environmental model. The dynamic acoustics adjustment program 150 may utilize CNNs to identify objects within an image, such as flora, buildings, living entities, etc. The dynamic acoustics adjustment program 150 may utilize RNNs to identify patterns within data, such as the sound of vehicle traffic or the sound of ocean waves. The dynamic acoustics adjustment program 150 may utilize SVMs to classify data, such as identifying a type of environment (e.g., forest or urban center).

In at least one embodiment, the dynamic acoustics adjustment program 150 may utilize the captured contextual information to determine the current and projected flight paths of the UAV. If the UAV is operating in a swarm (i.e., a group of UAVs), the dynamic acoustics adjustment program 150 may utilize the contextual information to identify the projected path of the center of the swarm. For example, if the swarm is flying in a particular formation, the dynamic acoustics adjustment program 150 may identify the center of mass of the swarm and project the flight path of the center of mass in relation to the overall swarm. The dynamic acoustics adjustment program 150 may utilize the current and projected flight path of the UAV(s) to identify when the UAV may come within a threshold distance of living entities (e.g., humans), landmarks, events, activities, or other objects. The dynamic acoustics adjustment program 150 may identify the threshold distance as a preconfigured distance or a distance at which the living entities (e.g., humans), landmarks, events, activities, or other objects may be disturbed by the presence of the UAV.

Then, at 210, the dynamic acoustics adjustment program 150 identifies one or more dominant sounds within a soundscape of the analyzed contextual information. The dynamic acoustics adjustment program 150, through UAV onboard sensors, may analyze the contextual information of the soundscape in order to identify dominant sounds. The dynamic acoustics adjustment program 150 may also utilize data, such as a weather report, from one or more external sources, such as remote database 130, to identify sounds that may be present in the environment. For example, the dynamic acoustics adjustment program 150 may obtain weather information to indicate that a rainstorm is occurring or will occur in a specific period of time. Furthermore, the dynamic acoustics adjustment program 150 through the soundscape analysis may identify the location of the source of the one or more dominant sounds, the type of sound, and the dominant frequency of the sound.

Through the soundscape analysis to identify the one or more dominant sounds, the dynamic acoustics adjustment program 150 may utilize Fourier transform and/or wavelet transform. Fourier transform is a mathematical concept that decomposes functions, such as soundwaves, into frequency components. The dynamic acoustics adjustment program 150 may utilize Fourier transforms to decompose the captured soundwaves within the contextual information to identify the dominant frequency within the soundwave. Wavelet transform is a mathematical concept that decomposes a function into a wavelet or a set of wavelets. A wavelet is a wave-like oscillation localized in time. The dynamic acoustics adjustment program 150 may utilize wavelet transform and the resulting wavelets to identify the location of the source of a sound.

Using the soundwave frequency and the wavelets of the dominant sounds and images captured from one or more UAV onboard sensors, the dynamic acoustics adjustment program 150 may identify the activity associated with the one or more dominant sounds. The dynamic acoustics adjustment program 150 may identify the activity through comparisons of the soundwave frequency and the wavelets of the dominant sounds to known frequencies and wavelets in a repository, such as storage 124 or remote database 130, and image recognition techniques of the captured images.

Then, at 212, the dynamic acoustics adjustment program 150 calculates an impact of UAV operation on the one or more activities. The impact may be utilized to understand how the sounds emitted from the UAV affects the soundscape of the environment and the living entities in the environment. The dynamic acoustics adjustment program 150 may perform an impact analysis using the captured contextual information to identify when the UAV is in operation and how that operation is affecting the environment. The dynamic acoustics adjustment program 150 may perform an impact analysis through identification of the activities taking place in the environment and how the UAV's operation may be affecting those activities based on the sounds produced both by the activities and the UAV. In at least one embodiment, the dynamic acoustics adjustment program 150 may utilize the processed contextual information resulting from step 210. For example, the dynamic acoustics adjustment program 150 may ingest the frequency components and wavelets resulting from Fourier transform and wavelet transform, respectively. Furthermore, the impact analysis may also utilize data from external sources, such as remote database 130, to identify an impact of the UAV on the environment. In order perform the impact analysis, the dynamic acoustics adjustment program 150 may utilize one or more of A-weighting, A-weighted sound pressure level equivalent (Lp(A)eq), sound mapping, and acoustic modeling.

The dynamic acoustics adjustment program 150 may utilize A-weighting and Lp(A)eq to calculate the prevalence and magnitude associated with the one or more dominant sounds on the surrounding environment. A-weighting is a sound measuring process that accounts for the relative loudness of a sound as perceived by the human ear. The dynamic acoustics adjustment program 150 may utilize A-weighting to identify the loudness of a sound produced by the UAV in the relative soundscape of the environment. For example, the dynamic acoustics adjustment program 150 may utilize A-weighting to determine the extent to which a human can hear the UAV in operation over various soundscapes. Lp(A)eq is a measure of the sound level that would be produced by a source if it were producing sound at a constant level that would produce the same A-weighted sound level as that produced by the source.

The dynamic acoustics adjustment program 150 may utilize sound mapping and acoustic modeling and propagation to generate a map of the soundscape. The dynamic acoustics adjustment program 150 may utilize the generated soundscape map to determine specific areas that the UAV should avoid or, when traversing, the UAV should modify specific aspects of aerial traversal. Sound mapping is a process of generating digital geographic maps through association of landmarks and soundscapes. Acoustic modeling and propagation relates the generation of a three-dimensional model of the soundscape through sound propagation. Acoustic modeling details the propagation of soundwaves of an activity and the UAV through the mapped soundscape resulting from the sound mapping. The dynamic acoustics adjustment program 150 may utilize a computer simulation, physical modeling, or experimental testing in a controlled environment to generate the acoustic model. For example, the dynamic acoustics adjustment program 150, through acoustic modeling and propagation, may generate an acoustic model to study how sound waves from a jet engine propagate through the environment. Therefore, the dynamic acoustics adjustment program 150 may utilize sound mapping to identify the location of sound sources (e.g., activities) around an environment and acoustic modelling and propagation to determine the extent to which the soundwaves generated by the activities propagate through the environment.

Next, at 214, the dynamic acoustics adjustment program 150 determines whether the calculated impact affects the one or more activities. The dynamic acoustics adjustment program 150 may determine that the impact affects an activity within the soundscape when the sounds generated by the UAV are disruptive to the activity. The soundwaves generated by the UAV may be considered disruptive when an individual or entity engaging in the activity can hear, or is affected by, the soundwaves above a threshold level or if noise generated by the UAV, in any way, affects the activity. For example, the dynamic acoustics adjustment program 150 may determine that the UAV disrupts the activity when any individual participating in the activity can hear the sounds generated by the UAV. As a further example, if the noise generated by a UAV affects a performing musician in a manner that causes the musician to miss a note, the dynamic acoustics adjustment program 150 may determine that the UAV is causing a disruption. The dynamic acoustics adjustment program 150 may determine the disruption occurring when the sounds generated by the UAV are audible to an individual over the sounds of the activity.

The dynamic acoustics adjustment program 150 may identify a disruption by an individual partaking in an activity is any level of sound generated by the UAV audible to the individual above a threshold value. For example, the threshold level may be configured for all sounds audible to individuals, all sounds that may cause hearing damage, or all sounds audible to a specific group (e.g., higher frequencies audible to children). In at least one embodiment, the dynamic acoustics adjustment program 150 may establish the threshold level on an individual basis if individual hearing sensitivities are known and available to the dynamic acoustics adjustment program 150 through a repository.

In at least one embodiment, the dynamic acoustics adjustment program 150 may determine whether an individual is disrupted by the sounds of the UAV based on the impact calculated in step 212 compared to the threshold value. If the dynamic acoustics adjustment program 150 determines the impact does affect the identified activity (step 214, “Yes” branch), then the dynamic acoustics adjustment process 200 may proceed to step 216 to modify UAV operation to reduce or eliminate the determined impact. If the dynamic acoustics adjustment program 150 determines the impact does not affect the identified activity (step 214, “No” branch), then the dynamic acoustics adjustment process 200 may return to step 206 to capture contextual information of the environment surrounding the UAV.

Then, at 216, the dynamic acoustics adjustment program 150 modifies UAV operation to reduce or eliminate the determined impact. If the dynamic acoustics adjustment program 150 determines that the impact of the UAV does affect the one or more activities, the dynamic acoustics adjustment program 150 may modify the operation of the UAV to reduce or eliminate the impact. The dynamic acoustics adjustment program 150 may make modifications in real-time in response to changes in the environment and soundscape that indicate the impact is causing a disruption of the activity. The dynamic acoustics adjustment program 150 may make one or more modifications including, but not limited to, power management, flight path planning, and operational acoustic emission reduction.

Power management relates to the regulation of energy consumption by the UAV. As previously described, UAVs may be powered by variety of sources, such as, but not limited to, internal combustion engines, solar-power, or battery power. Depending on the power source, a UAV may generate noise simply by being powered-on. The dynamic acoustics adjustment program 150 may modify the UAV's ability to utilize power in order to lessen any impactful noise generated. For example, the dynamic acoustics adjustment program 150, through a power management system within the UAV, may lessen the power available to the UAV powered through an internal combustion engine while maintaining power levels necessary to maintain flight thereby reducing any noise generated by the UAV rotors. This power management also reduces any unnecessary carbon emissions into the environment and conserves resources.

Flight path planning relates to the calculation of a specific traversal path the UAV may take from a source location to a destination location. The dynamic acoustics adjustment program 150 may alter a predetermined flight path when traversal along that flight path may cause a disruption to an activity. For example, if a delivery UAV's predetermined flight path causes the UAV to fly over an outdoor lecture and that traversal will impact the activity, the dynamic acoustics adjustment program 150, through a flight path planning system, may calculate an alternate traversal path, such as flying downwind or at a higher altitude, that avoids the sound generated from the UAV's operation from being heard by any individual observing the lecture.

Operational acoustic emission reduction relates to the reduction of noise generated by the operating functions of a UAV. Operational functions may relate to any system a UAV utilizes to traverse from a source to a destination. Although discussed with reference to power management, a UAV power source may also be considered an operational function. The dynamic acoustics adjustment program 150, through an acoustic emission reduction system, may regulate various aspects of UAV operating functions, such as, but not limited to, rotor speed, shape, length, and/or material, in order to reduce, minimize, and/or eliminate the impact of the UAV's operation on an activity. For example, in the preceding example where a lecture is occurring below a UAV's predetermined flight path, rather than calculating a new flight path that avoids the lecture, the dynamic acoustics adjustment program 150 may determine that, based on the altitude of the predetermined traversal path, a reduction in rotor speed may be sufficient to allow the UAV to travel over the lecture without causing a disruptive impact on the lecture.

In one or more embodiments, the dynamic acoustics adjustment program 150 modifications to the UAV may result in the UAV emitting a sound profile that mimics the sound frequency of the dominant sounds identified in step 210 thereby masking the UAV's operational presence. For example, when a UAV is flying need a waterfall overlook, the dynamic acoustics adjustment program 150 may modify the sound profile of the UAV through power management and operation acoustic emission reduction to mimic the sound frequency of the water flowing through the waterfall so as not to disturb, or minimally disturb, any individuals or fauna near the waterfall.

It may be appreciated that FIG. 2 provides only an illustration of one implementation and does not imply any limitations with regard to how different embodiments may be implemented. Many modifications to the depicted environments may be made based on design and implementation requirements. In one or more other embodiments, the dynamic acoustics adjustment program 150 may consider that an activity consisting of many individuals may differing impacts on each individual. For example, if the activity is a music concert, the dynamic acoustics adjustment program 150 may determine that individuals nearer to the UAV's operation may be impacted more severely that individuals farther way from the UAV's operation.

Additionally, the dynamic acoustics adjustment program 150 may be capable of determining that individuals may be impacted differently based on personal circumstances. For example, an individual participating in a group activity may have hearing sensitivities not affecting all individuals in the group. The dynamic acoustics adjustment program 150 may identify individuals with varying sensitivities to the UAV's operation through information captured through the UAV's onboard sensors, such as a camera. For example, the dynamic acoustics adjustment program 150 may identify a child on a playground is covering their ears while a UAV is approaching while nearby adults are not, which may signify the UAV's operational frequency is affecting children more severely than adults due to a child's ability to hear higher frequency sounds that are inaudible to adults. As such, the dynamic acoustics adjustment program 150 may modify the UAV's operation to reduce, minimize, or eliminate the impact on each individual in the activity.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
capturing contextual information of an environment surrounding an unmanned aerial vehicle (UAV);
generating an environmental model using a cluster of machine learning techniques based on the captured contextual information;
identifying one or more dominant sounds within a soundscape of the captured contextual information;
calculating an impact of an operation of the UAV on one or more activities within the environment based on the generated environmental model and the one or more identified dominant sounds; and
in response to determining the calculated impact affects an activity within the one or more activities, modifying the operation to minimize the impact on the soundscape.

2. The method of claim 1, further comprising:
registering a UAV to a central repository;
evaluating soundwaves generated by the UAV using an audible pitch monitoring apparatus;
generating an acoustics model for the UAV based on the evaluated soundwaves.

3. The method of claim 1, wherein the cluster comprises a convolutional neural network, a recurrent neural network, and a support vector machine.

4. The method of claim 1, wherein identifying the one or more dominant sounds further comprises performing Fourier transform and wavelet transform on the contextual information.

5. The method of claim 2, wherein identifying the one or more dominant sounds further comprises identifying a location of a source of the one or more dominant sounds, a type of sound of the one or more dominant sounds, and a dominant frequency of the one or more dominant sounds.

6. The method of claim 1, wherein calculating the impact further comprises utilizing A-weighting, Lp(A)eq, sound mapping, and acoustic modeling.

7. The method of claim 1, wherein the contextual information is any information relevant to the environment as captured by one or more visual sensors, one or more audio sensors, one or more location sensors, and one or more motion sensors.

8. A computer system, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
capturing contextual information of an environment surrounding an unmanned aerial vehicle (UAV);
generating an environmental model using a cluster of machine learning techniques based on the captured contextual information;
identifying one or more dominant sounds within a soundscape of the captured contextual information;
calculating an impact of an operation of the UAV on one or more activities within the environment based on the generated environmental model and the one or more identified dominant sounds; and
in response to determining the calculated impact affects an activity within the one or more activities, modifying the operation to minimize the impact on the soundscape.

9. The computer system of claim 8, further comprising:
registering a UAV to a central repository;
evaluating soundwaves generated by the UAV using an audible pitch monitoring apparatus;
generating an acoustics model for the UAV based on the evaluated soundwaves.

10. The computer system of claim 8, wherein the cluster comprises a convolutional neural network, a recurrent neural network, and a support vector machine.

11. The computer system of claim 8, wherein identifying the one or more dominant sounds further comprises performing Fourier transform and wavelet transform on the contextual information.

12. The computer system of claim 9, wherein identifying the one or more dominant sounds further comprises identifying a location of a source of the one or more dominant sounds, a type of sound of the one or more dominant sounds, and a dominant frequency of the one or more dominant sounds.

13. The computer system of claim 8, wherein calculating the impact further comprises utilizing A-weighting, Lp(A)eq, sound mapping, and acoustic modeling.

14. The computer system of claim 8, wherein the contextual information is any information relevant to the environment as captured by one or more visual sensors, one or more audio sensors, one or more location sensors, and one or more motion sensors.

15. A computer program product, the computer program product comprising:
one or more computer-readable tangible storage media and program instructions stored on at least one of the one or more tangible storage media, the program instructions executable by a processor capable of performing a method, the method comprising:
capturing contextual information of an environment surrounding an unmanned aerial vehicle (UAV);
generating an environmental model using a cluster of machine learning techniques based on the captured contextual information;
identifying one or more dominant sounds within a soundscape of the captured contextual information;
calculating an impact of an operation of the UAV on one or more activities within the environment based on the generated environmental model and the one or more identified dominant sounds; and
in response to determining the calculated impact affects an activity within the one or more activities, modifying the operation to minimize the impact on the soundscape.

16. The computer program product of claim 15, further comprising:
registering a UAV to a central repository;
evaluating soundwaves generated by the UAV using an audible pitch monitoring apparatus;
generating an acoustics model for the UAV based on the evaluated soundwaves.

17. The computer program product of claim 15, wherein the cluster comprises a convolutional neural network, a recurrent neural network, and a support vector machine.

18. The computer program product of claim 15, wherein identifying the one or more dominant sounds further comprises performing Fourier transform and wavelet transform on the contextual information.

19. The computer program product of claim 16, wherein identifying the one or more dominant sounds further comprises identifying a location of a source of the one or more dominant sounds, a type of sound of the one or more dominant sounds, and a dominant frequency of the one or more dominant sounds.

20. The computer program product of claim 15, wherein calculating the impact further comprises utilizing A-weighting, Lp(A)eq, sound mapping, and acoustic modeling.
